(19) United States
(12) Patent Application Publication
(10) Pub. No.: US 2019/0174669 A1
(43) Pub. Date: Jun. 13, 2019

(54) PORTABLE AND LIGHTWEIGHT SEEDING DEVICE

(71) Applicant: WALDANIA TANI SDN BHD, Dengkil, Selangor (MY)

(72) Inventors: Othman MOHAMMAD FITRI, Dengkil (MY); Othman MUHAMMAD RIDZUAN, Dengkil (MY); Othman MOHAMMAD FIRHAN, Dengkil (MY); Othman SIDIQ FADHIL, Dengkil (MY)

(73) Assignee: WALDANIA TANI SDN BHD, Dengkil, Selangor (MY)

(21) Appl. No.: 16/324,530

(22) PCT Filed: Aug. 9, 2017
(86) PCT No.: PCT/MY2017/000029

§ 371 Date: Feb. 8, 2019

(30) Foreign Application Priority Data
Aug. 10, 2016 (MY) PI 2016702905

(51) Int. Cl. A01C 7/20; A01C 7/08; A01C 7/02

(52) U.S. Cl. CPC A01C 7/20; A01C 7/02; A01C 7/08

(57) ABSTRACT

A portable seeding device for seed planting in a seed tray includes a seed holding plate having perforations for retaining a supply of seed on said plate and distributing the seeds on said holding plate. A vacuum chamber accumulates vacuum pressure and is in contact with the seed holding plate. A vacuum generator applies a vacuum effect within the vacuum chamber. A handle formed on the vacuum chamber allows single-handed manipulation of the seeding device. The vacuum generator is formed integral to the handle. Upon applied vacuum effect within the vacuum chamber, vacuum draw is applied to the seeds on the holding plate such that the seeds are held onto the perforations of the seed holding plate. The device is thereafter held invertedly over the seed tray and the vacuum effect is ceased, whereupon the seeds are released from the perforations into the seed tray to plant the seeds.

### FIELD OF INVENTION

The present invention generally relates to seeding devices and systems; and more particularly to a device for facilitating planting of seeds.

### BACKGROUND OF INVENTION

At present, it is frequently desirable to distribute a supply of seeds on a multi-segmented seeding tray prior to being transferred to a nursery or other suitable planting areas. With the aid of the seeding tray, the seeds can be arranged in a manner such that they will have sufficient space to evolve or develop. Owing to the size and typically large number of seeds to be distributed, the task of manually distributing the seeds, particularly by hand can be time consuming and arduous so as to ensure that the seeds are accurately allocated within each segment or compartment of the seeding tray. Inaccuracy and misplacing of seeds can result to disrupted growth and wastage of seed supply. To partially address this problem, a variety of machines and apparatuses have been developed to enable or offer an automated mechanism of seeds distribution in a seeding tray. However, a great majority of these machines comprises multiple complicated parts thereby a user may face difficulties in handling or manipulating them. Further, having multiple complicated parts normally results to complexity and substantial maintenance requirement.

An example of prior art seeding apparatus is disclosed in U.S. Pat. No. 4,573,609 issued to Tesch, whereby there is provided an apparatus for distributing seeds into proper position in a rectangular array on a flat or seed planting tray in a semi-automated process. The apparatus comprises two separate parts, one being a seed distribution tray having a flat top plate with a rectangular array of perforations therein of a size smaller than the seeds to be planted, and upright side walls surrounding the top plate on all sides, and a vacuum cleaner that is connected to the distribution tray by means of a hose, the vacuum cleaner for applying vacuum draw to the seed distribution tray. Perceptibly, with multiple separate parts, the apparatus is adapted in a manner such that it would have to be operated by two persons, one for handling the distribution tray to evenly allocate the seeds thereon, and for manipulating the vacuum supply. Such necessity can be extensively cumbersome in the event that only one operator is available for the seed planting task. Apart from this, mobility is limited as an operator is required to carry both separated parts—including the vacuum cleaner to the seeding location or area.

An object of the present invention is to mitigate at least one of the glaring shortcomings of conventional seeding devices and apparatuses as discussed above.

### SUMMARY OF INVENTION

In one aspect, the present invention provides a portable seeding devise for seed planting in a seed tray comprising: a seed holding plate comprising perforations adapted for retaining a supply of seed on said plate and for distributing the seeds on said holding plate; a handle formed on the vacuum chamber adapted for single-handed manipulation of the seeding device a vacuum chamber adapted for accumulating vacuum pressure and is in contact with the seed holding plate; a vacuum generator integrally provided adjacent to the handle for applying a vacuum effect within the vacuum chamber; wherein upon applied vacuum effect within the vacuum chamber, vacuum draw is applied to the seeds on the holding plate such that the seeds are held onto the perforations of the seed holding plate; after which the device is held invertedly over the seed tray and the vacuum effect is ceased, the seeds are released from the perforations into the seed tray to plant the seeds.

Preferably, the seed holding plate further comprising a seed tray guide adapted to be slidable along at least one side surface of the vacuum chamber for aligning the seed holding plate with the seed tray.

Preferably, the vacuum chamber includes an extension formed on each sidewall adapted for receiving the seed tray guide to provide slidable movement along said extension.

In a preferred embodiment, the seed tray guide comprises an elongated bracket having an aperture and a locking mechanism for securing the elongated bracket at a predetermined position along the sidewalls of the vacuum chamber.

The locking mechanism includes a strip with notches, at least one end of the strip is adapted to be insertable through an aperture formed on the elongated bracket. To secure or lock the bracket at the predetermined position along the sidewall of the vacuum chamber, the strip is inserted into the aperture, and the notches preventing the withdrawal of the strip out of the aperture.

The portable seeding device further comprises a seed sump for storing or holding the seeds when the device is inverted over the seed tray. The seed sump is removably secured on at least one sidewall of the vacuum chamber.

Preferably, the seed tray guide comprises a pair of brackets; each of which is adapted to be slidable along at least one side surface of the seed holding plate and a locking mechanism for securing said brackets at a desired position along said sidewalls.

The seed tray guide permits adjustments based on a single axis or dual axis.

Preferably, the portable seeding device further comprising a power cord connected to the vacuum generator for providing electrical power supply to the vacuum generator.

The perforations on the seed holder plate are adapted for retaining a supply for seeds at varying sizes; and are formed space apart from each other at a predetermined distance.

In the preferred embodiment, the seed holding plate includes a perforated portion, and sidewalls extending vertically from the perforated portion, wherein the perforated portion of the seed holding plate is in contact with the vacuum chamber.

The vacuum chamber is sized to accommodate the seed holding plate and includes vacuum chamber includes a raised portion to accommodate the vacuum generator.

### BRIEF DESCRIPTION OF THE DRAWINGS

The embodiments of the present invention will be more understood by reference to the description below taken in conjunction with the accompanying drawings herein:

FIG. 1 shows an overall view of the seeding device in accordance with an embodiment of the present invention;

FIG. 2 shows an elevated view of the seed holding plate in accordance with an embodiment of the present invention;

FIG. 3 illustrates the seed tray guide members with the locking mechanism in accordance with an embodiment of the present invention;

FIG. 4A-FIG. 4C illustrate several perspective views of the vacuum chamber in accordance with an embodiment of the present invention;

FIG. 5 illustrates the vacuum generator of the seeding device in accordance with an embodiment of the present invention;

FIG. 6 shows an elevated view of the seed sump of the seeding device in accordance with an embodiment of the present invention.

FIG. 7 shows the steps involved in operating the seeding device in accordance with an embodiment of the present invention.

### DETAILED DESCRIPTION OF THE EMBODIMENTS

In line with the above summary, the following description of a number of specific and alternative embodiments is provided to understand the inventive features of the present invention. It shall be apparent to one skilled in the art, however that this invention may be practiced without such specific details. Some of the details may not be described at length so as not to obscure the invention. For ease of reference, common reference numerals will be used throughout the figures when referring to the same or similar features common to the figures.

The seeding device of the present invention is adapted to be portable, lightweight and can be operated single-handedly. All members of the seeding device are constructed from plastic material and can be easily detached hence enabling modularity for ease of maintenance.

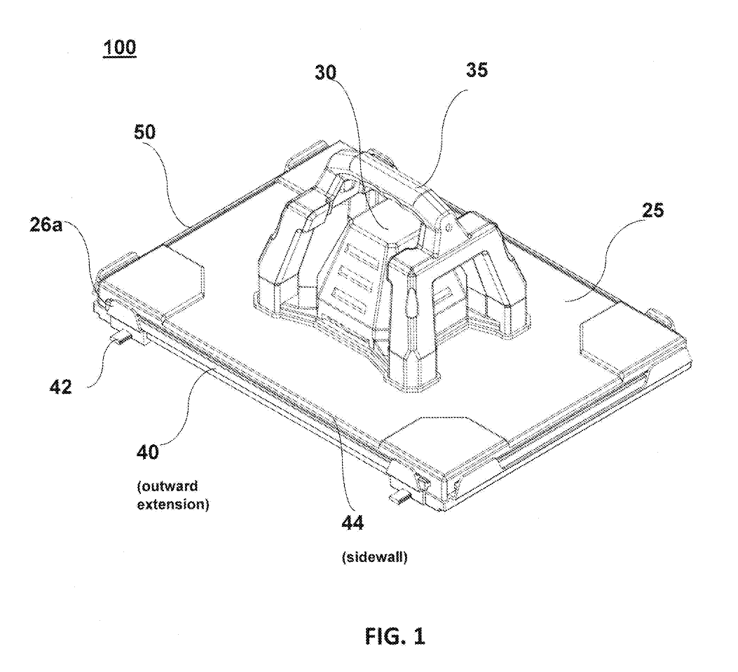

As best illustrated in FIG. 1, in one embodiment, the portable seeding device 100 for seed planting in a seeding tray comprises: a seed holding plate 20 having perforations adapted for retaining a supply of seed on said plate 20 and for distributing the seeds on said holding plate 20; a vacuum chamber 25 removably fitted or secured over at least one surface of the seed holding plate 20; a vacuum generator for applying a vacuum effect within the vacuum chamber 25; and a handle 35 formed on the vacuum chamber 25 for permitting single-handed manipulation or operation of the seeding device 100. The seeding device 100 further comprises a power supply unit with an electric power cord connected to the vacuum generator 30 for providing electrical power supply to the vacuum generator 30.

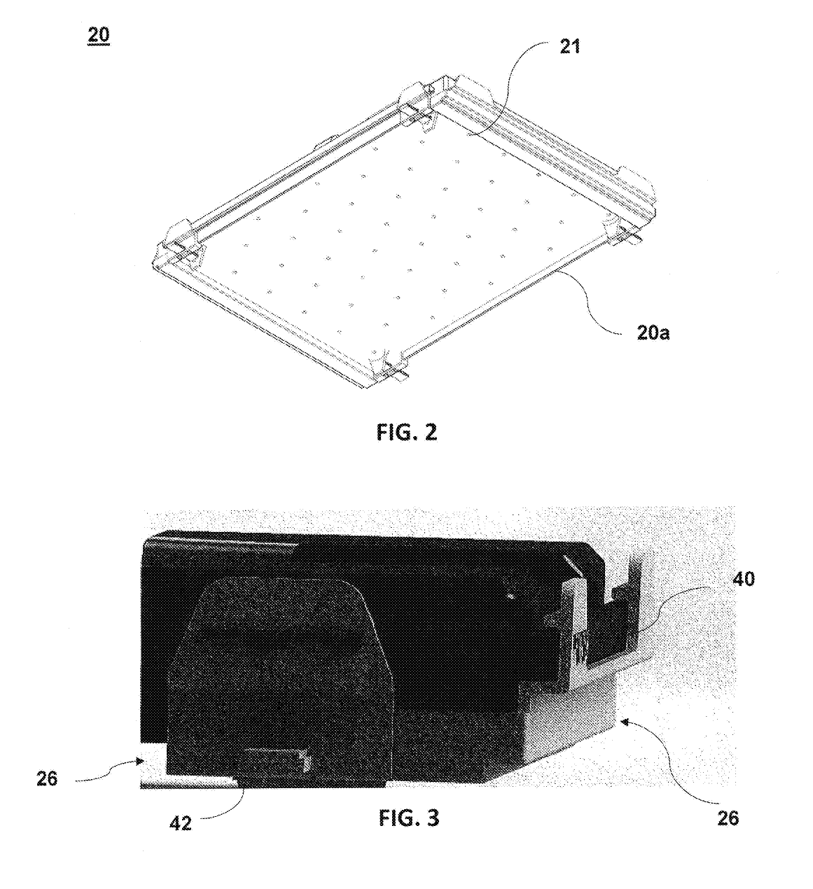

Now referring to FIG. 2, the seed holding plate 20 of the seeding device in FIG. 1 in accordance with an embodiment of the present invention can be of any geometrical design, preferably rectangular or square. Perforations 21 are formed on at least one surface of the holding plate 20, for retaining a supply of seed whereby the type of perforations include tapered or non-tapered. In another preferred embodiment, there may be provided two usable surfaces of the plate 20, whereby one surface is formed with tapered perforations to accommodate spherical and round type of seeds, while the non-tapered perforations are for accommodating flat and pointy type of seeds. The perforations are adapted for retaining a supply for seeds at varying sizes; and are formed space apart from each other at a predetermined distance.

The seed plate 20 comprises a perforated portion 20b, whereby the perforated portion 20b of the seed holding plate 20 is adapted to be engage-able with the Vacuum chamber 25 and secured thereto by suitable fastening means. The seed holding plate 20 can be constructed by any conventional machining process.

As shown in FIG. 3, the seed tray guide 26 is adapted to be slidable or adjustable along at least one sidewall 44 of the vacuum chamber 25 for aligning the seed holding plate with the seed tray. In a preferred embodiment, the tray guide 26 is removably secured to the sidewalls 44 of the vacuum chamber 25. There are two interchangeable types of tray guide 26 adjustments, the first being a single axis adjustment and second is dual axis adjustment. The single axis adjustment is effected when there is only a lateral or horizontal adjustment required, while the dual axis adjustment is effected when both horizontal and vertical adjustments are required, in relation to fitting the seeding device 100 over the seeding tray.

In one embodiment, to provide a second axis of adjustment, the seed tray guide 26 comprises a pair of elongated brackets 26a; each of which is adapted to be slidable along at least one side surface of the vacuum chamber 25 and a locking mechanism for securing said brackets 26a at a desired position along said sidewalk 44 of the vacuum chamber 25. Each of the elongated brackets 26a includes an aperture 41 accordingly sized to receive a member of the locking mechanism to secure the position of the bracket 26a onto the sidewall of the vacuum chamber 25. Each of the brackets 26a is attached to the sidewall 44 in a snap-fit manner, hence locking the bracket 26a in position.

In a preferred embodiment, the locking mechanism 26b includes an elongated strip 42 having a plurality of regularly spaced notches 43. In order to secure a bracket 26a at a desired predetermined position, one end of the elongated strip 42 is inserted into the aperture 41 and the movement of the strip 42 is restricted by means of the notches 43, thereby locking the bracket 26a at the current position. To lock the bracket 26a at the predetermined position along the sidewall of the vacuum chamber, the strip is inserted into the aperture, and the notches preventing the withdrawal of the strip out of the aperture. The adjustment of the bracket along the strip provides a second mechanism of adjusting or aligning the tray guide to the seeding tray.

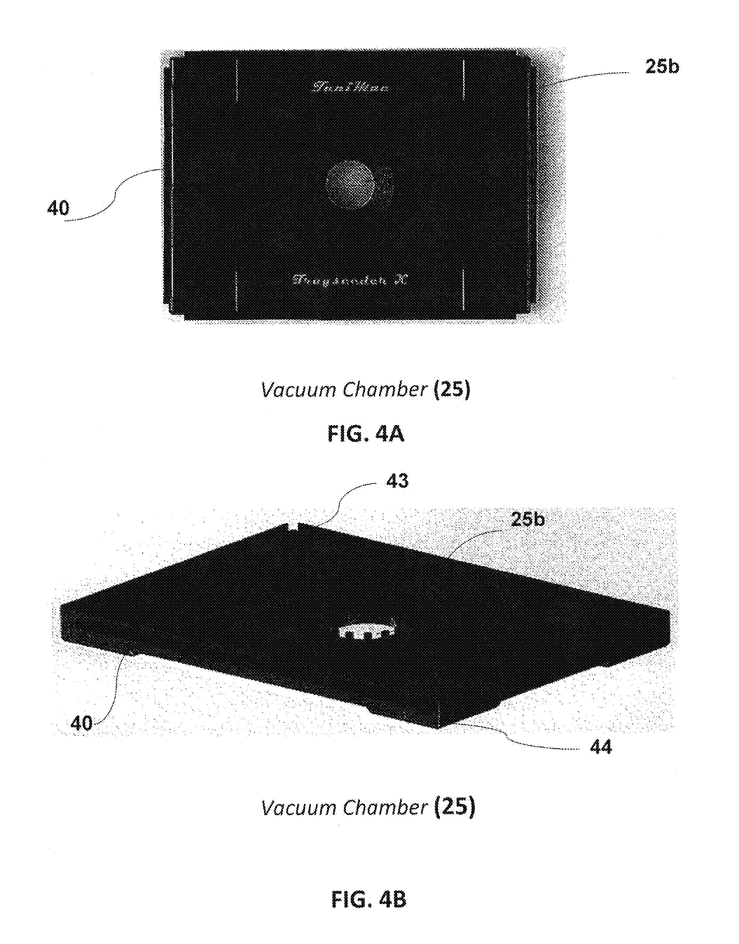

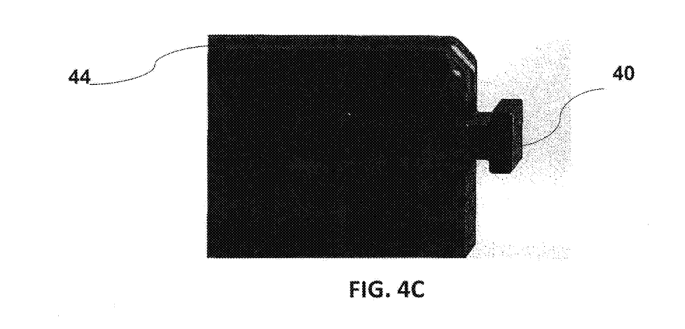

With reference now to FIG. 4A, the vacuum chamber 25 is generally sized to be fitted or secured over the seed holding plate 20, preferably having a shape and dimension corresponding to that of the seed holding plate 20. The vacuum chamber 25 can be detachably or removably secured over cat least one surface of the seed holding plate 20 in a manner such that a vacuum draw can be applied to the seed holding plate 20 for retaining or holding the supply of seeds within the perforations. The vacuum chamber 25 is adapted such that the vacuum pressure created can be accumulated; sufficient to hold at least 50 seeds of varying surface within the perforations of the seed holding plate 20.

In accordance with a preferred embodiment, the vacuum chamber 25 is a hollow member and generally rectangular in shape with sidewalls 44 and at least one surface is adapted to receive the seed holding plate 20. The inner surface of the chamber 25 is accordingly adapted to provide support for the flexible perforated portion 20b of the seed holding plate 20 during vacuum draw. In one embodiment, the vacuum chamber 25 is constructed with thin but wide surface so as to maintain the optimal volume of vacuum area. As seen in FIG. 4A, an opening 25b is formed on the top surface of the chamber 25, accordingly sized to receive a cylindrical member of the vacuum generator 30, an arrangement which will be further elucidated herein. The opening 25b is accordingly adapted with a sealing surface so as to prevent the vacuum from being released. As shown in FIG. 4B, in order to provide further support and secure the seed holding plate 20 in its position, for example, the vacuum chamber 23 may comprise cut out portions or a recess on each corner, suitably sized to correspondingly receive the corners of the seed holding plate 20, hence support the plate 20 therein.

Referring to FIGS. 4A, 4B and 4C, each of the sidewalls 44 of the vacuum chamber 25 includes an outward extension 40 suitably sized to fit the elongated brackets 26a of the seed tray guide 26, and adapted for permitting slidable movement of the elongated brackets 26a.

In accordance with the preferred embodiment, a top surface the vacuum chamber 25 includes a portion to accommodate an integral vacuum generator 30 for creating a vacuum environment within the vacuum chamber 25, while a bottom surface is in contact with seed holding plate 20, and more particularly the perforated surface 20b of the seed holding plate 20. In the preferred embodiment, there is provided a raised portion sufficiently sized to accommodate the vacuum generating means 30, whereby the raised portion is positioned in relation to the seed holding plate 20 such that the vacuum created is applied to the perforated surface 20b of the seed holding plate 20.

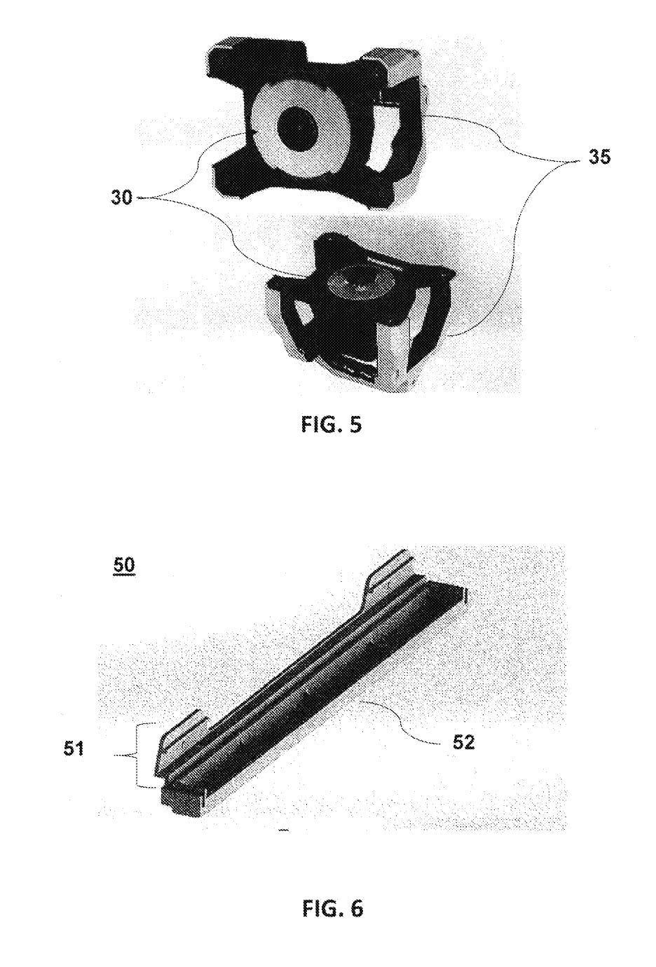

Now referring to FIG. 5, the vacuum generator 30 comprises a motor, a vacuum impeller and a housing. In the preferred embodiment, the motor and vacuum impeller are connected in a manner such that the motor provides movement for the vacuum impeller. The housing is generally cylindrical and is adapted for enclosing both the vacuum impeller and the motor, in which the housing facilitates in dampening the noise of the motor and absorbs the sheer force created by the motor during operation. The housing may include at least one air outlet, and a power cord to be connected to an electrical power supply for activating the vacuum generator 30. When assembled, the cylindrical housing comprising the impeller and motor is extended towards the opening 25b of the vacuum chamber 25.

The vacuum generator 30 further includes a handle 35 adapted for a single-handed manipulation of the seeding device 100. Accordingly, the vacuum generator 30 maybe integrally formed adjacent to the handle 35. In the preferred embodiment, the handle 35 is positioned centrally and is extending upwardly from the top surface of the vacuum chamber 25. To ease manipulation and handling of the seeding device, the handle 35 is configured to fit the size of male adult hand grip and permitting an ON-OFF switch reach to activate and inactivate the seeding device 100. It is adapted such that the device 100 can be held by both left-handed and right-handed operator. The ON-OFF switch may be located at position on the handle 35 that is easily reachable when holding the device 100. In one example of geometrical configuration, the handle 35 comprises a pair of arch-like members positioned perpendicular to each other forming an X-shape configuration to create a solid holding feature.

The seeding device 100 in accordance with the preferred embodiment of the present invention further comprises a seed sump 50, adapted to be removably or detachably secured to at least one sidewall of the vacuum chamber 25. The seed sump 50 as shown in FIG. 6 prevents the seeds from falling when the seeding device 100 is inverted during use, and is able to contain approximately 300 pieces of seeds. In one configuration, the seed sump 50 may be secured along the length of the vacuum chamber 25 sidewall by means of suitable fastening means such as clamps, clips or any form of locking mechanism that permits the sump 50 to be removed or dismantled whenever desired. Still referring to FIG. 6, the seed sump comprises a slide support portion 51 and a receptacle 52 extending horizontally from the support portion. The receptacle 52 comprises multiple segments for receiving seeds.

The securement of the seed sump 50 to the vacuum chamber 25 aids to hold the seed holding plate 20 in place in relation to the vacuum chamber 25.

Upon assembled, the vacuum chamber 25 with the integral vacuum generator 30 are positioned and detachably secured over the seed holding plate 20, wherein upon applied vacuum effect within the vacuum chamber 25, vacuum draw is applied to the seeds on the holding plate 20 such that the seeds are held onto the perforations of the seed holding plate after which the device is held over the seed tray and the vacuum effect is ceased, the seeds are released from the perforations into the seed tray to plant the seeds.

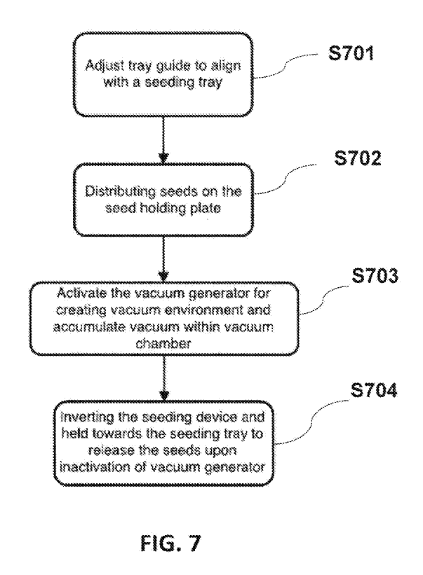

FIG. 7 shows a flowchart depicting the steps in operating the seeding device 100 in accordance with the preferred embodiment of the present invention. During use, the tray guide 26 is accordingly adjusted to align the seed holding plate of the seeding device 100 to the seed tray, at S701. Next at S702, seeds of varying sizes are spread over the perforated portion 20b of the seed holding plate 20, and are accordingly distributed thereon to allocate the seeds within the perforations. The vacuum generator 30 is activated at S703 to create a vacuum atmosphere within the vacuum chamber 25, thereby applying a vacuum draw on the perforated portion 20b of the seed holding plate 20 to retain the seeds therein. The operator may single-handedly tilt the seed holding plate by means of the handle 35 to evenly distribute the seeds on the seed holding plate 20, and to allocate the seeds within the perforations. At S704, the seeding device 100 is inverted and positioned over the seed tray in a manner such that the perforated portions filled with the seeds, of the seed holding plate 20 is in contact with the segmented portion of a conventional or standard seed tray. In this process, the tray guide 26 may be re-adjusted accordingly to set or align the seed holding plate 20 to the seed tray. Once they are aligned, the vacuum generator 30 is inactivated hence ceasing the vacuum draw to the seeds, thereby releasing them into the segments of the seed tray.

As would be apparent to a person having ordinary skilled in the art, the afore-described methods and components may be provided in many variations, modifications or alternatives to existing seeding devices. The principles and concepts disclosed herein may also be implemented in various manner which may not have been specifically described herein but which are to be understood as encompassed within the scope and letter of the following claims.

1. A portable seeding device for seed planting in a seed tray comprising:
a seed holding plate comprising perforations adapted for retaining a supply of seed on said plate and for distributing the seeds on said holding plate;
a vacuum chamber adapted for accumulating vacuum pressure and is in contact with the seed holding plate;
a handle formed on the vacuum chamber;
a vacuum generator for providing vacuum pressure:
wherein the vacuum generator is integrally provided adjacent to the handle for applying a vacuum effect within the vacuum chamber; and for single handed manipulation of the seeding device;
wherein upon applied vacuum effect within the vacuum chamber, vacuum draw is applied to the seeds on the holding plate such that the seeds are held onto the perforations of the seed holding plate; after which the device is held invertedly over the seed tray and the vacuum effect is ceased, the seeds are released from the perforations into the seed tray to plant the seeds;
wherein the seed holding plate having a seed tray guide is adapted to be slidable along at least one side surface of the vacuum chamber for aligning the seed holding plate with the seed tray, and the seed tray guide having an elongated bracket with an aperture and a locking mechanism for securing the elongated bracket at a predetermined position along the sidewalls of the vacuum chamber.

2. (canceled)

3. The portable seeding device as claimed in claim 1 wherein the vacuum chamber includes an extension formed on each sidewall adapted for receiving the seed tray guide to provide slidable movement along said extension.

4. (canceled)

5. The portable seeding device as claimed in claim 1 wherein the locking mechanism includes a flat strip with notches, at least one end of the strip is adapted to be insertable through an aperture formed on the elongated bracket.

6. The portable seeding device as claimed in claim 3, wherein to lock the bracket at the predetermined position along the sidewall of the vacuum chamber, the strip is inserted into the aperture, and the notches preventing the withdrawal of the strip out of the aperture.

7. The portable seeding device as claimed in claim 1, further comprising a seed sump for storing or holding the seeds when the device is inverted over the seed tray.

8. The portable seeding device as claimed in claim 5, wherein the sump is removably secured on at least one sidewall of the vacuum chamber.

9. The portable seeding device as claimed in claim 1, wherein the seed tray guide comprises a pair of brackets; each of which is adapted to be slidable along at least one side surface of the seed holding plate and a locking mechanism for securing said brackets at a desired position along said sidewalls.

10. The portable seeding device as claimed in claim 1 wherein the seed tray guide permits adjustments based on a single axis or dual axis.

11. The portable seeding device as claimed in claim 1, further comprising a power cord connected to the vacuum generator for providing electrical power supply to the vacuum generator.

12. The portable seeding device as claimed in claim 1, wherein the perforations are adapted for retaining a supply for seeds at varying sizes; and are formed space apart from each other at a predetermined distance.

13. The portable seeding device as claimed in claim 1, wherein the seed holding plate includes a perforated portion, and sidewalls extending vertically from the perforated portion.

14. The portable seeding device as claimed in claim 11 wherein the perforated portion of the seed holding plate is in contact with the vacuum chamber.

15. The portable seeding device as claimed in claim 1 wherein the vacuum chamber is sized to accommodate the seed holding plate.

16. The portable seeding device as claimed in claim 1 wherein the vacuum chamber includes a raised portion to accommodate the vacuum generator.
